(19) United States
(12) Patent Application Publication
(10) Pub. No.: US 2008/0013447 A1
(43) Pub. Date: Jan. 17, 2008

(54) Method and Apparatus for Survivable Failover in Communication System

(76) Inventor: Pamela J. Lauber, Middletown, NJ (US)

Correspondence Address: Ryan, Mason & Lewis, LLP, 90 Forest Avenue, Locust Valley, NY, 11560, US

(21) Appl. No.: 11/757,583

(22) Filed: Jun. 4, 2007

Related U.S. Application Data
(60) Provisional application No. 60/830,961, filed on Jul. 14, 2006.

(51) Int. Cl. G06F 11/00

(52) U.S. Cl. 370/225

(57) ABSTRACT

Techniques are disclosed for call failover in a communication protocol for facilitating establishment of communication sessions between devices. For example, a method for maintaining, in the presence of a failure, an existing communication session between a first communication device and a second communication device in a communication system, wherein the communication session is established in accordance with an original signaling path between the first communication device and the second communication device, includes the following steps. Occurrence of a failure in the communication system is determined. An alternate signaling path is established between the first communication device and the second communication device such that the first communication device and the second communication device can continue the existing communication session using the alternate signaling path. When the communication session is conducted in accordance with a Session Initiation Protocol (SIP), the message sent to initiate establishment of the alternate signaling path may be an INVITE message with a Replaces header.

### CROSS REFERENCE TO RELATED APPLICATION

This application claims priority to the U.S. provisional patent application identified by Ser. No. 60/830,961, filed on Jul. 14, 2006, and entitled “Survivable Failover Architecture for SIP Signaling,” the disclosure of which is incorporated by reference herein.

### FIELD OF THE INVENTION

The present invention relates generally to the field of communication systems, and more particularly to Session Initiation Protocol (SIP) or other types of communication protocols for facilitating establishment of communication sessions between devices.

### BACKGROUND OF THE INVENTION

SIP is a well-known signaling protocol that is commonly utilized in conjunction with voice over Internet protocol (VoIP) communications, wireless communications, and in numerous other communications contexts. SIP is widely used, for example, in call setup, call disconnect and call feature implementation for various types of communications. SIP is described in, for example, Internet Engineering Task Force (IETF) RFC 3261, “SIP: Session Initiation Protocol,” June 2002, which is incorporated by reference herein.

Certain aspects of conventional SIP signaling can be problematic in the presence of failures, such as application failures or network failures. For example, assume that a call has been successfully established using SIP signaling and, while the call is ongoing, there is some type of application or network failure. Currently, when this happens, if either the calling party or the called party tries to use call features (e.g., call hold, call transfer, multi-party call conferencing, bridged call appearance, etc.), the call will be terminated and the call path will be torn down.

Accordingly, there is a need for survivable call failover in SIP or other types of communication protocols for facilitating establishment of communication sessions between devices.

### SUMMARY OF THE INVENTION

Principles of the invention provide for call failover in a communication protocol for facilitating establishment of communication sessions between devices.

For example, in a first aspect of the invention, a method for maintaining, in the presence of a failure, an existing communication session between a first communication device and a second communication device in a communication system, wherein the communication session is established in accordance with an original signaling path between the first communication device and the second communication device, includes the following steps. Occurrence of a failure in the communication system is determined. An alternate signaling path is established between the first communication device and the second communication device such that the first communication device and the second communication device can continue the existing communication session using the alternate signaling path.

Establishment of the alternate signaling path may enable at least one of the first communication device and the second communication device to utilize a call feature in accordance with the communication session. Further, establishment of the alternate signaling path may enable at least one of the first communication device and the second communication device to initiate a termination of the communication session.

Establishment of the alternate signaling path may be accomplished via an alternate network device. One of the first communication device and the second communication device may initiate establishment of the alternate signaling path by sending a message to the alternate network device. The communication session may be conducted in accordance with a Session Initiation Protocol (SIP) and the message sent to initiate establishment of the alternate signaling path may be an INVITE message with a Replaces header. The alternate network device may forward the message sent to initiate establishment of the alternate signaling path to the other one of the first communication device and the second communication device. The alternate signaling path may be established after acceptance and acknowledgement messages are exchanged between the first communication device and the second communication device via the alternate network device. The failure may include one of an application failure and a network failure.

In a second aspect of the invention, apparatus in a first communication device for use in maintaining, in the presence of a failure, an existing communication session between the first communication device and a second communication device in a communication system, wherein the communication session is established in accordance with an original signaling path between the first communication device and the second communication device, includes a memory and at least one processor coupled to the memory and operative to: (i) determine that a failure in the communication system has occurred; and (ii) cause establishment of an alternate signaling path between the first communication device and the second communication device such that the first communication device and the second communication device can continue the existing communication session using the alternate signaling path. The first communication device and the second communication device may be Session Initiation Protocol (SIP) enabled communication devices.

In a third aspect of the invention, apparatus in a network device for use in maintaining, in the presence of a failure, an existing communication session between a first communication device and a second communication device in a communication system, wherein the communication session is established in accordance with an original signaling path between the first communication device and the second communication device, includes a memory and at least one processor coupled to the memory and operative to: (i) receive a message from one of the first communication device and the second communication device, upon occurrence of a failure in the communication system, the message being intended to cause establishment of an alternate signaling path between the first communication device and the second communication device such that the first communication device and the second communication device can continue the existing communication session using the alternate signaling path; and (ii) forward the message to the other one of the first communication device and the second communication device. The memory and the at least one processor may be implemented in one or more of a proxy and call controller.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 illustrates an example of a survivable call controller failover architecture according to an embodiment of the invention.

FIG. 2 illustrates another example of a survivable call controller failover architecture according to an embodiment of the invention.

FIG. 3 illustrates a survivable call failover methodology according to an embodiment of the invention.

FIG. 4 illustrates a computing architecture of a device for use in implementing survivable call failover according to an embodiment of the invention.

### DETAILED DESCRIPTION OF PREFERRED EMBODIMENTS

Although described below primarily in the context of the SIP signaling protocol, it is to be appreciated that principles of the present invention can be readily adapted in a straightforward manner to other types of communication protocols for facilitating establishment of communication sessions between devices.

An illustrative embodiment makes use of the SIP Replaces header described in IETF RFC 3891, “The Session Initiation Protocol (SIP) “Replaces” Header,” September 2004, which is incorporated by reference herein.

In general, as described in RFC 3891, the Replaces header field indicates that a single dialog identified by the header field is to be shut down and logically replaced by the incoming INVITE in which it is contained. Thus, the Replaces header contains information used to match an existing SIP dialog (call-id, to-tag, and from-tag) intended to be replaced with a new SIP dialog. Upon receiving an INVITE with Replaces header, the receiving device attempts to match this information with a confirmed or earlier dialog. The receiving device matches to-tag and from-tag parameters as if they were tags present in an incoming request. In other words, the to-tag parameter is compared to the local tag, and the from-tag parameter is compared to the remote tag. Assuming a successful authorization process, the receiving device attempts to accept the new INVITE, reassign the user interface and other resources of the matched dialog to the new INVITE, and shut down the replaced dialog. Conventional SIP signaling procedures utilize the Replaces header to enable certain call features such as attended call transfer, retrieve from park, and transition from locally mixed conferences to two party calls in a didtributed peer-to-peer manner.

However, in the presence of failures, such as application failures or network failures, during an ongoing call using the conventional SIP signaling protocol, if either of the calling parties tries to use call features (e.g., call hold, call transfer, multi-party call conferencing, bridged call appearance, etc.), the call may be terminated and the call path may be torn down.

As will be described below, illustrative principles of the invention overcome drawbacks of conventional SIP signaling by providing an arrangement in which the signaling path will failover to an alternate SIP proxy and call controller in the presence of a failure, so that the parties on the call can continue to use call features and when the call is finished, the call path and signaling can be gracefully torn down. That is, one party can then initiate an orderly and intended termination of the communication session, as opposed to an abrupt and unintended termination that a failure would otherwise cause.

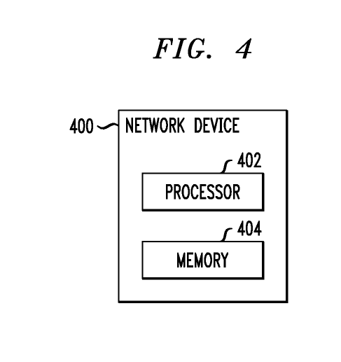

The illustrative embodiment can be implemented in, for example, a gateway or other network processing device comprising a processor and memory (an example of which is described below in the context of FIG. 4). The disclosed techniques are broadly applicable to many other products, applications, and network services that use the SIP protocol or other types of signaling protocols and are operating in a failover environment. For example, the disclosed techniques are particularly well suited for use in SIP failover scenarios involving IP telephony and wireless applications.

The illustrative embodiment, although described in the context of utilization of one or more of the above-noted call features, can also be used in other contexts, such as, for example, tearing down a pre-established call in a more graceful way after either the calling party or called party disconnects.

In the illustrative embodiment, when an application or network failure occurs during an active call, the end user telephone or other device sends a SIP INVITE message containing a Replaces header to an alternate SIP proxy and call controller. The INVITE message containing the Replaces header requests that a new call session be established to replace the old call session. Identifying information for the new and old call sessions are contained in the SIP INVITE message that contains the Replaces header. The format of the SIP Replaces header is described in the above-cited IETF RFC 3891.

This approach advantageously expands the use of the SIP Replaces header to failover scenarios, and provides call features and graceful teardown for calls that have already been established when an application or network failure occurs.

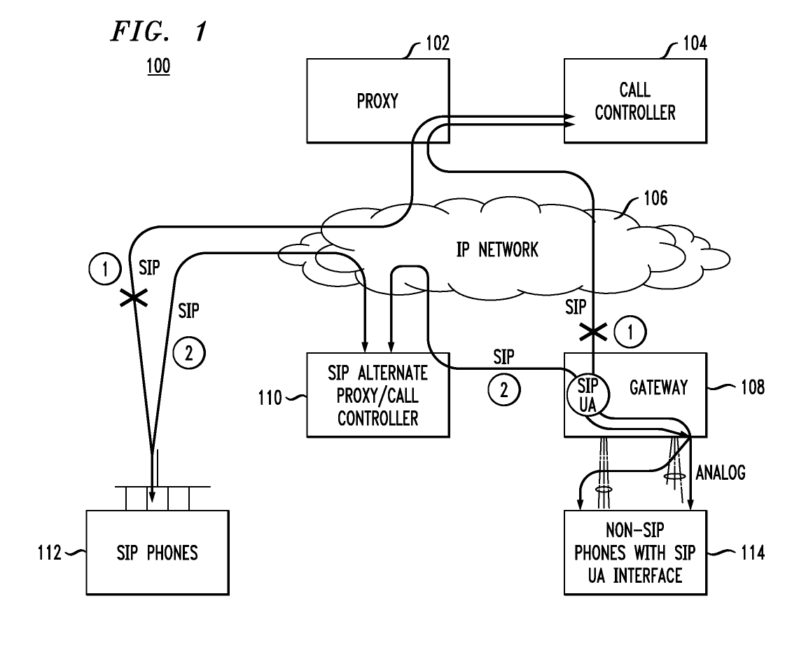

FIG. 1 shows an example of a survivable call controller failover architecture 100 in the illustrative embodiment of the invention. In this example, an ongoing call is established via SIP signaling as indicated generally by the communication paths designated by numeral 1. These paths traverse first proxy 102 and call controller 104, as shown, as well as IP network 106 and gateway 108 which includes a SIP user agent (UA).

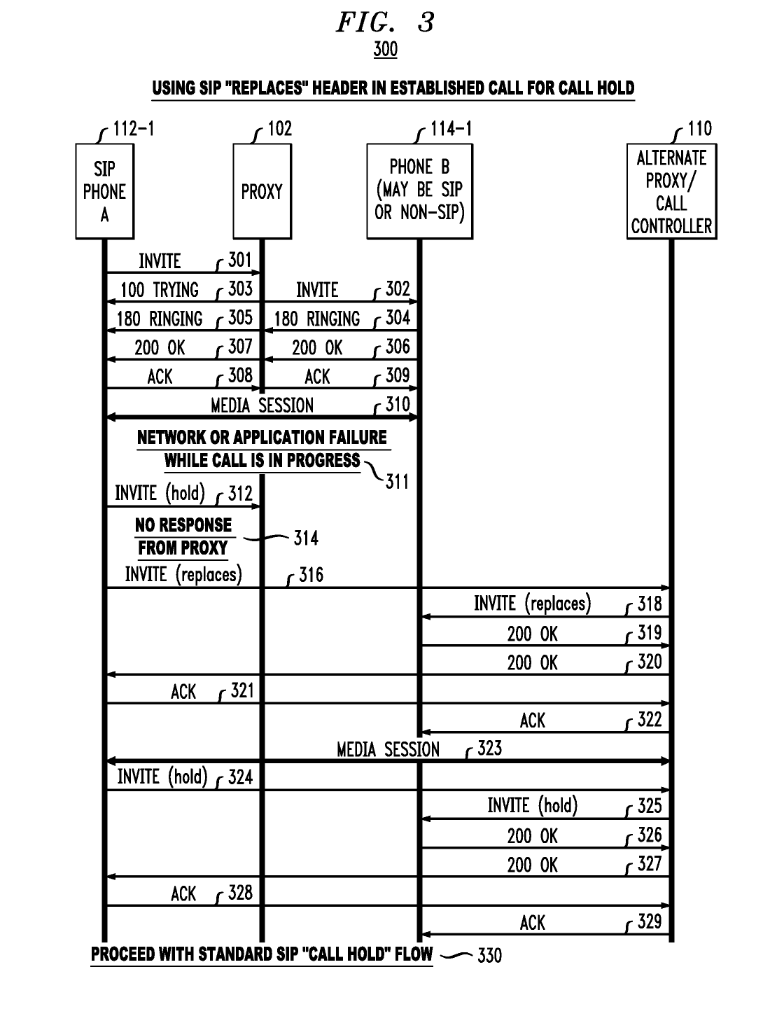

Assume that a failure occurs while this call is active, as indicated by the large X in the communication paths designated by numeral 1. As noted above, this failure may be associated with an application or network failure, or may be another type of failure. In the presence of the failure, the active call will failover to alternate proxy and call controller 110, as indicated generally by the communication paths designated by numeral 2. This is accomplished using the signaling shown in the signaling diagram of FIG. 3.

The end user devices in the FIG. 1 example may be SIP phones 112 or non-SIP phones 114 having SIP UA interfaces, as indicated. Other types of end user devices may be used in other embodiments.

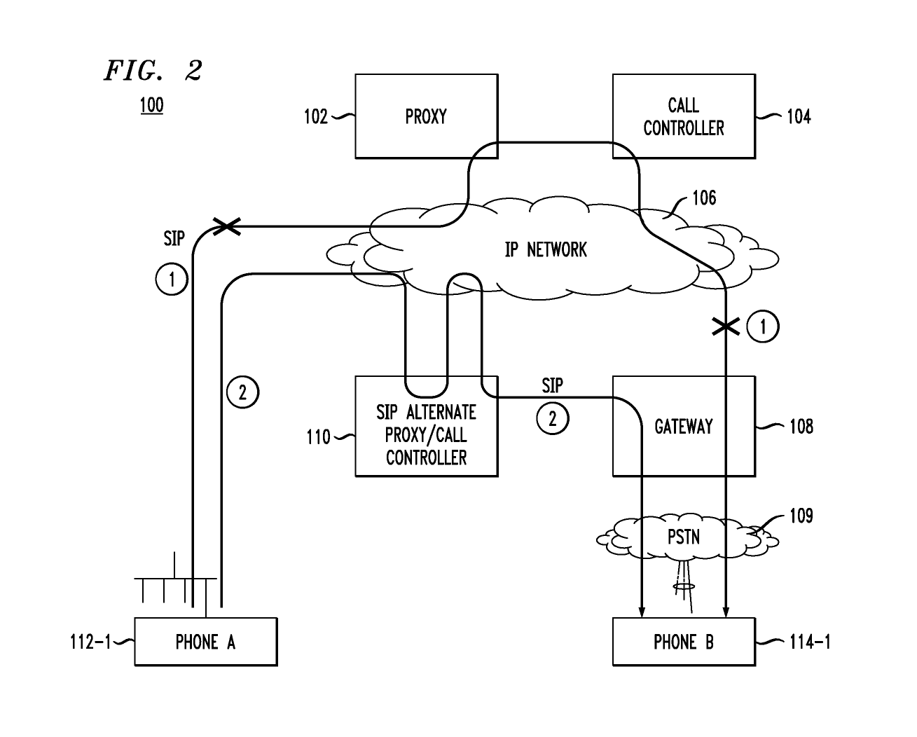

Referring now to FIG. 2, a more particular example of the FIG. 1 arrangement is shown, in which the two end user devices are specifically identified as Phone A (112-1) and Phone B (114-1). It is assumed that Phone A in this example is a SIP phone, although Phone B need not be a SIP phone (and thus is shown being connected to gateway 108 via PSTN (Public Switched Telephone Network) 109. Thus, the signaling type for Phone B is unrestricted in this example. Again, principles of the present invention does not require the use of SIP signaling, but is particularly advantageous in that context.

It is to be understood that the network configurations shown in FIGS. 1 and 2 are intended to be illustrative in nature. That is, the non-SIP phones may be coupled to the IP network in a variety of different configurations. By way of an additional example, the non-SIP phones may be coupled to the IP network through a terminal adaptor wherein the terminal adaptor is collocated in a device with a gateway that is itself coupled to PSTN trunks. Of course, a variety of other configurations are possible and thus the failover techniques of the invention are not limited to any particular configuration.

FIG. 3 illustrates the manner in which the SIP Replaces header is utilized to provide failover to the above-noted alternate proxy and call controller (110), for an active call between Phone A (112-1) and Phone B (114-1) in the FIG. 2 example. The signaling diagram 300 of FIG. 3 shows the communications between system elements including SIP Phone A (112-1), the original proxy (102), Phone B (114-1) and the alternate proxy and call controller (110). Again, Phone B in this embodiment may be a SIP phone or a non-SIP phone, or other type of end user device. Also, it is to be understood that other network components (not expressly shown) could be involved in the SIP signaling communications.

In this embodiment, a media session is established between Phone A and Phone B as shown. That is, in accordance with SIP signaling procedures, Phone A sends an INVITE message to the proxy (301). The proxy forwards the INVITE to Phone B (302) and indicates (TRYING message) to Phone A that the INVITE is pending with Phone B (303). Phone B sends out a RINGING message (304) that is forwarded to Phone A by the proxy (step 305). Phone B accepts the INVITE by sending out an OK message (306) that is forwarded to Phone A by the proxy (step 307). Phone A sends out an ACK message (308) that is forwarded to Phone B by the proxy (step 309). The media session is thus established between Phone A and Phone B (310).

While this call (session) is in progress, assume an application or network failure occurs (311). The user at Phone A then attempts to use a call feature, in this example a hold feature, which is initiated via an associated INVITE message (312). Due to the failure, there is no response from the proxy to the INVITE message associated with the hold feature (314).

Phone A then sends an INVITE message that contains a Replaces header of the type described above to the alternate proxy and call controller (316). The alternate proxy and call controller forwards the INVITE with Replaces header to Phone B (318). Phone B accepts the INVITE with Replaces header by sending out an OK message (319) that is forwarded to Phone A by the alternate proxy and call controller (step 320). Phone A sends out an ACK message (321) that is forwarded to Phone B by the alternate proxy and call controller (step 322). The media session is thus maintained between Phone A and Phone B (323).

The user at Phone A can then utilize the hold feature, or other types of call features as desired, as the call has now advantageously failed over to the alternate proxy and call controller. More specifically, Phone A sends an INVITE (hold) message to Phone B via the alternate proxy and call controller (324 and 325). An acceptance message is sent by Phone B (326 and 327), which is acknowledged by Phone A (328 and 329). Then, communications proceed as per standard SIP “call hold” flow (330).

It should be noted that signaling similar to that shown in FIG. 3 can be adapted in a straightforward manner to any situation in which Phone A or Phone B, or more generally other end user devices, invokes a call feature or disconnects as long as the signaling to the alternate proxy and call controller uses SIP as its signaling protocol. As indicated previously, alternative embodiments of the invention may use other types of protocols.

The alternate proxy and call controller may be an otherwise conventional SIP proxy and call controller. The proxy and call controller may be implemented as separate devices or may be combined into a single device. The conventional aspects of the operation of such devices, as well as other system elements such as the gateway and SIP UA are well known to those skilled in the art and are therefore not described in further detail herein.

A given system element, such as one or more of the proxies, call controllers, gateways or other elements, may be implemented as one or more network devices or other types of processing devices including at least a processor and a memory. The present invention can be implemented at least in part in the form of software programs that are stored by a memory and executed by a processor in one or more system elements.

It is to be appreciated that the above-described embodiment is presented by way of example only. Numerous alternative embodiments will be readily apparent to those skilled in the art. For example, the invention can be implemented using other types of end user devices and other types of system or network elements. Also, alternative techniques may be used to convey alternate proxy or call controller information instead of the Replaces header of the illustrative embodiment.

Lastly, FIG. 4 illustrates a computing architecture 400 of a network processing device for use in implementing the failover techniques of the invention. That is, FIG. 4 may be considered a computing architecture used to implement the proxies, call controllers, gateways, end users devices, or other elements. Of course, it is to be understood that the invention is not limited to any particular computing system implementation.

In this illustrative implementation, a processor 402 for implementing at least a portion of the methodologies of the invention is operatively coupled to a memory 404.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., hard drive), removable storage media (e.g., diskette), flash memory, etc.

Accordingly, one or more computer programs, or software components thereof, including instructions or code for performing the methodologies of the invention, as described herein, may be stored in memory 404 and, when ready to be utilized, loaded in whole or in part and executed by the processor 402.

In any case, it is to be appreciated that the techniques of the invention, described herein and shown in the appended figures, may be implemented in various forms of hardware, software, or combinations thereof, e.g., one or more operatively programmed general purpose digital computers with associated memory, implementation-specific integrated circuit(s), functional circuitry, etc. Given the techniques of the invention provided herein, one of ordinary skill in the art will be able to contemplate other implementations of the techniques of the invention.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A method for maintaining, in the presence of a failure, an existing communication session between a first communication device and a second communication device in a communication system, wherein the communication session is established in accordance with an original signaling path between the first communication device and the second communication device, the method comprising the steps of:
determining that a failure in the communication system has occurred; and
establishing an alternate signaling path between the first communication device and the second communication device such that the first communication device and the second communication device can continue the existing communication session using the alternate signaling path.

2. The method of claim 1, wherein establishment of the alternate signaling path enables at least one of the first communication device and the second communication device to utilize a call feature in accordance with the communication session.

3. The method of claim 1, wherein establishment of the alternate signaling path enables at least one of the first communication device and the second communication device to initiate a termination of the communication session.

4. The method of claim 1, wherein establishment of the alternate signaling path is accomplished via an alternate network device.

5. The method of claim 4, wherein one of the first communication device and the second communication device initiate establishment of the alternate signaling path by sending a message to the alternate network device.

6. The method of claim 5, wherein the communication session is conducted in accordance with a Session Initiation Protocol (SIP) and the message sent to initiate establishment of the alternate signaling path comprises an INVITE message with a Replaces header.

7. The method of claim 5, wherein the alternate network device forwards the message sent to initiate establishment of the alternate signaling path to the other one of the first communication device and the second communication device.

8. The method of claim 7, wherein the alternate signaling path is established after acceptance and acknowledgement messages are exchanged between the first communication device and the second communication device via the alternate network device.

9. The method of claim 1, wherein the failure comprises one of an application failure and a network failure.

10. Apparatus in a first communication device for use in maintaining, in the presence of a failure, an existing communication session between the first communication device and a second communication device in a communication system, wherein the communication session is established in accordance with an original signaling path between the first communication device and the second communication device, comprising:
a memory; and
at least one processor coupled to the memory and operative to: (i) determine that a failure in the communication system has occurred; and (ii) cause establishment of an alternate signaling path between the first communication device and the second communication device such that the first communication device and the second communication device can continue the existing communication session using the alternate signaling path.

11. The apparatus of claim 10, wherein establishment of the alternate signaling path enables at least one of the first communication device and the second communication device to utilize a call feature in accordance with the communication session.

12. The apparatus of claim 10, wherein establishment of the alternate signaling path enables at least one of the first communication device and the second communication device to initiate a termination of the communication session.

13. The apparatus of claim 10, wherein the at least one processor is further operative to initiate establishment of the alternate signaling path by sending a message to an alternate network device.

14. The apparatus of claim 13, wherein the communication session is conducted in accordance with a Session Initiation Protocol (SIP) and the message sent to initiate establishment of the alternate signaling path comprises an INVITE message with a Replaces header.

15. The apparatus of claim 13, wherein the alternate network device forwards the message sent to initiate establishment of the alternate signaling path to the second communication device.

16. The apparatus of claim 15, wherein the alternate signaling path is established after acceptance and acknowledgement messages are exchanged between the first communication device and the second communication device via the alternate network device.

17. The apparatus of claim 10, wherein the first communication device and the second communication device are Session Initiation Protocol (SIP) enabled communication devices.

18. Apparatus in a network device for use in maintaining, in the presence of a failure, an existing communication session between a first communication device and a second communication device in a communication system, wherein the communication session is established in accordance with an original signaling path between the first communication device and the second communication device, comprising:
a memory; and
at least one processor coupled to the memory and operative to: (i) receive a message from one of the first communication device and the second communication device, upon occurrence of a failure in the communication system, the message being intended to cause establishment of an alternate signaling path between the first communication device and the second communication device such that the first communication device and the second communication device can continue the existing communication session using the alternate signaling path; and (ii) forward the message to the other one of the first communication device and the second communication device.

19. The apparatus of claim 18, wherein the memory and the at least one processor are implemented in one or more of a proxy and call controller.

20. The apparatus of claim 18, wherein the communication session is conducted in accordance with a Session Initiation Protocol (SIP) and the message sent to initiate establishment of the alternate signaling path comprises an INVITE message with a Replaces header.
